(19) United States
(12) Patent Application Publication
(10) Pub. No.: US 2014/0207557 A1
(43) Pub. Date: Jul. 24, 2014

(54) ONLINE BARTERING SERVICE

(71) Applicant: KT CORPORATION, Gyeonggi-do (KR)

(72) Inventors: Ra-Woon CHOI, Seoul (KR); Jeong-Wook LEE, Seoul (KR); Kyung-Ah HAN, Daejeon (KR); Dong-Wan KIM, Seoul (KR); Kwang-Hyun BAEK, Daejeon (KR)

(73) Assignee: KT CORPORATION, Gyeonggi-do (KR)

(21) Appl. No.: 14/161,904

(22) Filed: Jan. 23, 2014

(30) Foreign Application Priority Data
Jan. 23, 2013 (KR) 10-2013-0007290

(51) Int. Cl. G06Q 30/02

(52) U.S. Cl. CPC G06Q 30/0239
USPC 705/14.39

(57) ABSTRACT

The disclosure is related to providing an online bartering service. The online bartering service may include registering a trading coupon of first user equipment in response to a registration request from the first user equipment, providing information on a list of candidate coupons to the first user equipment based on information on the trading coupon of the first user equipment, receiving a trading offer message with information on a selected candidate coupon from the first user equipment and transmitting the trading offer message to second user equipment having the selected candidate coupon, and automatically processing a difference between the trading coupon and the selected candidate coupon in connection with associated virtual accounts upon receiving a trading acceptance message from the second user equipment.

### CROSS REFERENCE TO PRIOR APPLICATIONS

The subject matter of this application is related to U.S. patent application Ser. No. 14/050,677 filed Oct. 10, 2013 as Attorney Docket No.: (801.0101) and U.S. patent application Ser. No. 14/105,512 filed Dec. 13, 2013 as Attorney Docket No.: (801.0130), the teaches of which are incorporated herein in their entirety by reference.

The present application claims priority under 35 U.S.C. §119 to Korean Patent Application No. 10-2013-0007290 (filed on Jan. 23, 2013), which is hereby incorporated by reference in its entirety.

### BACKGROUND

Due to advanced technologies of wired and wireless communication, online bartering is becoming popular. A typical online bartering enables individuals to exchange digital goods or services with each other. However, such a typical online bartering process can be annoying and inconvenient to individuals. For example, when there is a difference in a value of target goods to be exchanged, compensation for such difference can be annoying and inconvenient.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a service server may provide an online bartering service to individuals through user equipment.

In accordance with another aspect of the present invention, a service server may search candidate goods or services each having a trading condition matched with that of a trading good and provide information on a list of the candidate goods or service as a search result to respective user equipment.

In accordance with still another aspect of the present invention, a service server may consider a maximum allowed difference to select a candidate good from goods registered at the service server and automatically process a difference between two goods to be exchanged in connection with associated virtual accounts.

In accordance with at least one embodiment of the present invention, a method may be provided for providing an online bartering service by a service server. The method may include registering a trading coupon of first user equipment in response to a registration request from the first user equipment, providing information on a list of candidate coupons to the first user equipment based on information on the trading coupon of the first user equipment, receiving a trading offer message with information on a selected candidate coupon from the first user equipment and transmitting the trading offer message to second user equipment having the selected candidate coupon, and automatically processing a difference between the trading coupon and the selected candidate coupon in connection with associated virtual accounts upon receiving a trading acceptance message from the second user equipment.

The registering a trading coupon of first user equipment may include receiving the registration request from the first user equipment with information on the trading coupon and a trading condition, extracting the information on the trading coupon and the trading conditions from the received registration request, and storing the extracted information on the trading coupon and the trading condition in association with information on the first user equipment in a database of the service server. The information on the trading coupon may include at least one of a name, a coupon type, a coupon image, a coupon identifier, a code pattern image, an applicable merchant, a valid period, a value, an Internet address of an issuance server, and an associated virtual account. The information on the trading condition of the trading good may include at least one of a maximum allowed difference, a preferred coupon type, a preferred applicable merchant, and a preferred valid period.

The providing a list of candidate coupons may include obtaining information on the trading coupon of the first user equipment and an associated trading condition, searching registered coupons each having a trading condition matched with the obtained trading condition of the trading coupon, generating a list of candidate coupons based on the searching result, and providing the generated list of the candidate coupons to the first user equipment.

The trading condition may include at least one of a maximum allowed difference, a preferred coupon type, a preferred applicable merchant, and a preferred valid period.

The searching registered coupons may include determining a registered coupon of other as a candidate coupon when a difference in value between the registered coupon and the trading coupon is equal to or smaller than a maximum allowed difference set as the trading condition of the trading coupon of the first user equipment.

The providing a list of candidate coupons may include among coupons previously registered at the service server, selecting coupons each having a value equal to a value of the trading coupon as the candidate coupons, among coupons previously registered at the service server, selecting coupons each having a value less than a value of the trading coupon as much as a maximum allowed difference set as the trading condition of the trading coupon as the candidate coupons, and among coupons previously registered at the service server, selecting coupons each having a value greater than a value of the trading coupons as much as the maximum allowed difference of the trading coupon.

The receiving a trading offer message may include obtaining information on the selected candidate coupon from the received trading offer message, determining user equipment having the selected candidate coupon, as the second user equipment, based on information on the selected candidate coupon which is stored in a database when the selected candidate coupon is registered in response to a registration request from the second user equipment, and transmitting the received trading offer message to the determined user equipment with information on the trading coupon.

The method may further include receiving the trading acceptance message from the second user equipment in response to the trading offer message and providing detailed information on the trading coupon of the first user equipment to the second user equipment and providing detailed information on the selected candidate coupon of the second user equipment to the first user equipment.

If the difference is equal to or smaller than a maximum allowed difference of the trading good, the automatically processing a difference may include calculating a difference in a value between the trading good and the selected candidate good, and compensating the first and second user equipment based on the calculated difference in connection with virtual accounts associated with the first and second user equipment. When a value of the trading coupon is greater than a value of the selected candidate coupon, the calculated difference may be automatically added to a virtual account associated with the first user equipment and the calculated difference may be automatically deducted from a virtual account associated with the second user equipment. When a value of the trading coupon is less than a value of the selected candidate coupon, the calculated difference may be automatically added to a virtual account associated with the second user equipment and the calculated difference may be automatically deducted from a virtual account associated with the first user equipment.

After the automatically processing, the method may include receiving a trading completion message from the first and second user equipment and providing information on a result of the processing the difference to the first and second user equipment.

After the automatically processing, the method may include changing information on the trading coupon as belonging to the second user equipment and information on the selected candidate coupon as belonging to the first user equipment and transmitting a coupon deletion message to the first and second user equipment. The first user equipment may delete information on the trading coupon and marks the trading coupon as traded in response to the coupon deletion message and the second user equipment may delete information on the selected candidate coupon and marks the selected candidate coupon as traded in response to the coupon deletion message.

In accordance with another embodiment of the present invention, a method may be provided for receiving an online bartering service at first user equipment. The method may include transmitting a request including information on a trading coupon and a trading condition thereof to a service server, receiving from the service server information on a list of candidate coupons each having a trading condition matched with the trading condition of the trading coupon, and transmitting a trading offer message including information on a selected candidate coupon to the service server.

The transmitting a request may include displaying a list of coupons stored in the first user equipment, receiving a selection input from an associated user for selecting one of the stored coupons, setting a trading condition of the selected coupon based on user inputs, and generating the request to include information on the selected coupon as the trading coupon and information on the trading condition thereof.

The setting a trading condition may include setting a maximum allowed difference for enabling the service server to select candidate coupons and to automatically process a difference between the trading coupon and a selected candidate coupon in connection with associated virtual accounts if a difference between the trading coupon and the selected candidate coupon is equal to or smaller than the maximum allowed difference.

The method may further include receiving from the service server information on a result of automatically processing a difference between the trading coupon and the selected candidate coupon in connection with a virtual account associated with the first user equipment and deleting the information on the trading coupon and marking the trading coupon as traded upon the receipt of a coupon deletion message from the service server.

In accordance with still another embodiment of the present invention, a service server may be provided for providing an online bartering service. The service server may be configured to register a trading coupon of first user equipment in response to a registration request from the first user equipment, to provide information on a list of candidate coupons to the first user equipment based on information on the trading coupon of the first user equipment, to receive a trading offer message with information on a selected candidate coupon from the first user equipment and transmit the trading offer message to second user equipment having the selected candidate coupon, and to automatically process a difference between the trading coupon and the selected candidate coupon in connection with associated virtual accounts upon receiving a trading acceptance message from the second user equipment.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates an online barter system in accordance with at least one embodiment;

FIG. 2 illustrates a service server for providing an online bartering service in accordance with at least one embodiment;

FIG. 3 illustrates an online bartering operation performed in user equipment in accordance with at least one embodiment;

FIG. 4 illustrates an online bartering operation performed in a service server in accordance with at least one embodiment; and

FIG. 5 illustrates an online bartering operation for bartering a coffee shop coupon with an ice cream shop coupon in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

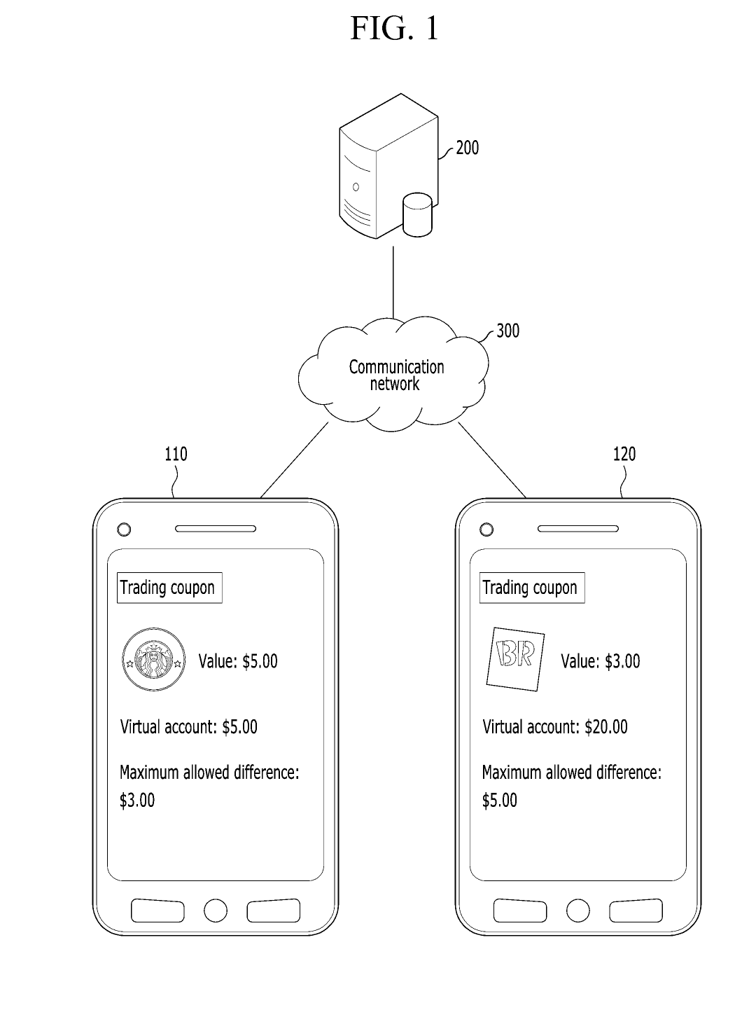

In accordance with at least one embodiment, a service server provides an online bartering service to individuals through user equipment. For example, a service server searches candidate goods or services each having a trading condition matched with that of a trading good and provides information on a list of the candidate goods or service as a search result to respective user equipment. The service server considers a maximum allowed difference to select a candidate good from goods registered at the service server and automatically processes a difference between two goods to be exchanged in connection with associated virtual accounts. Such an online bartering service may be provided through an online bartering system includes a service server and a plurality of user equipment coupled through a communication network. The online bartering system will be described with reference to FIG. 1.

FIG. 1 illustrates an online barter system in accordance with at least one embodiment. The online barter system enables individuals to exchange various types of digital goods through a communication network. For example, the online barter system enables individuals to exchange digital coupons to each other if the digital coupons have conditions satisfying trading conditions of both parties.

Referring to FIG. 1, such online barter system 100 may include service server 200 and a plurality of user equipments (e.g., first and second user equipment 110 and 120). For an online bartering service, user equipment 110 and 120 accesses service server 200 through communication network 300 and exchange necessary information with each other through communication network 300 for bartering digital goods or services in accordance with at least one embodiment.

Service server 200 may be a computing system of a service provider that provides an online bartering service to individuals. As described, the online bartering service might enable individuals to exchange digital goods or services through their user equipment. For example, service server 200 obtains information on digital goods to barter from first and second user equipment 110 and 120 and manages obtained information. Furthermore, service server 200 might post or provide such bartering information (e.g., a list of bartering goods) to first and second user equipment 110 and 120. Such an online bartering service may be provided through dedicated applications or web-pages. In order to provide such online bartering service, service server 200 provide at least one of dedicated applications to user equipment. That is, user equipment may download such dedicated applications and installs the downloaded application therein for receiving the online bartering service. However, the present invention is not limited thereto.

User equipment 110 and 120 each is an electronic device having processing power and capable of communicating with other entities through communication network 300. For example, user equipment 110 and 120 may include a personal computer (PC), a smartphone, a laptop computer, a personal digital assistance (PDA), a portable multimedia player (PMP), and a navigation device, but the present invention is not limited thereto.

Each individual uses such user equipment 110 and 120 for the online bartering service. For example, user equipment 110 and/or 120 accesses service server 200 through communication network 300, registers digital goods or services to trade (e.g., to barter, to exchange) at service server 200, and request service server 200 to provide the registered digital goods and/or services to others. During the registration, first and second user equipment 110 and 120 sets a trading condition (e.g., trading condition) of a trading good. The trading good is a good that an individual wants to trade. The trading condition or the trading condition may be condition for trading. That is, user equipment 110 and 120 sets a value (e.g., price), a maximum allowed difference, a preferred coupon type, a preferred applicable merchant, and so forth. That is, the trading condition or the trading condition includes information on a value, a maximum allowed difference, a preferred coupon type, and a preferred applicable merchant of each good.

The value denotes a value of a good, such as a price of a good. Each good has its own value but it might be set differently by an associated individual during the registration. The maximum allowed difference is a maximum difference in value, which an associated individual allows to automatically barter with a good belonging to others. For example, when the maximum allowed difference is set to $5.00, a trading good can be bartered with any goods having a value lower or higher than the value of the trading good as much as $5.00. That is, service server 200 searches for goods within a range of a maximum allowed difference and provides a list of the searched goods as candidate goods. When there is a difference between two goods, such a difference is automatically added to or deducted from an associated virtual account. The maximum allowed difference may be set within the balance in the associated virtual account.

The preferred coupon type indicates a type of a coupon that a user wants to have. That is, when a user wants to exchange one with a discount coupon, service server 200 searches for discount coupons having value similar to that of a trading good. The preferred applicable merchant is a coupon applicable to a desired merchant.

For example, a user registers a gift coupon of a coffee shop “Star Bucks” at service server 200 using first user equipment 110. Upon the registration, the user sets value of the coupon as $5.00 and a maximum allowed difference as $2.00. In this case, service server 200 might search goods or services having a value in a range of $3.00 to $7.00 from goods or services previously registered at service server 200 from others. Service server 200 provides information on the searched goods or services to first user equipment 110 as a list of candidate goods.

In FIG. 1, an exemplary graphic user interface of first user equipment 110 shows registering a coupon of Starbucks at service server 200 with a price of $5.00 and a maximum allowed difference of $3.00. Furthermore, an exemplary graphic user interface of second user equipment 120 shows registering a coupon of Baskin Robins with a price of $3.00 and a maximum allowed difference of $5.00 at service server 200. In this case, service server 200 may provide information on the Baskin Robins coupon, as a candidate coupon, to first user equipment 110 and provide information on the Starbucks coupon, as a candidate coupon, to second user equipment 120. This case occurs because their trading conditions (e.g., the prices and the maximum allowed differences) are matched with each other. After two parties are agreed to barter, service server 200 automatically process the difference of two coupons in connection with associated virtual accounts. For example, service server 200 adds $2.00 to a virtual account associated with first user equipment 110 and deducts $2.00 from a virtual account associated with second user equipment 120.

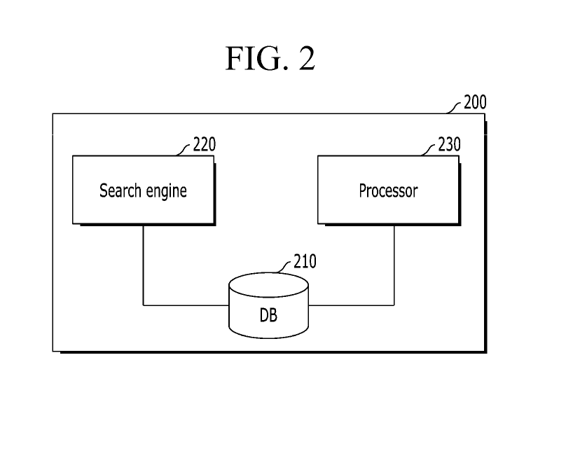

As described, service server 200 obtains and manages information on candidate goods, provides such information to user equipment 110 and 120 and performs operations for an online bartering service. Hereinafter, operation of service server 200 will be described with reference to FIG. 2.

FIG. 2 illustrates a service server for providing an online bartering service in accordance with at least one embodiment. Referring to FIG. 2, service server 200 includes database (DB) 210, search engine 220, and processor 230. In FIG. 2, service server 200 is schematically and briefly illustrated for convenience and ease of understanding. Although service server 200 is illustrated as including three constituent components in FIG. 2, the present invention is not limited thereto. For example, service server 200 may include a receiver and a transmitter for exchanging information with other parties for providing an online bartering service.

Database (DB) 210 stores information related to an online bartering service. Particularly, DB 210 stores information on goods that are registered for bartering at service server 200 by a plurality of user equipment. Such registered good information may include a name, a coupon type, a coupon image, a coupon identifier, a code pattern image, an applicable merchant, a valid period, a value, associated user equipment, an Internet address of an issuance server (e.g., a server of an issuance company), and so forth. DB 210 further stores information on a trading condition of each registered good. The information on the trading condition may include a maximum allowed difference, a preferred coupon type, a preferred applicable merchant, a preferred valid period, and so forth. DB 210 also stores information on a virtual account linked to respective user equipment and information on respective user equipment. DB 210 may store such information in a form of a mapping table.

For example, a user registers a digital coupon at service server 200 using an associated user equipment (e.g., first user equipment 110) and service server 200 stores information on the digital coupon in DB 210. While registering, service server 200 may perform a validating process for verifying validity of the digital coupon in connection with an associated server. In this case, service server 200 stores information on only verified digital coupon in DB 210.

In addition, DB 210 may store an online bartering application. For example, user equipment may download the online bartering application from DB 210 of service server 200 and install the downloaded online bartering application therein. In this case, the online bartering service may be provided through a graphic user interface produced and displayed on user equipment as the result of execution of the online bartering application.

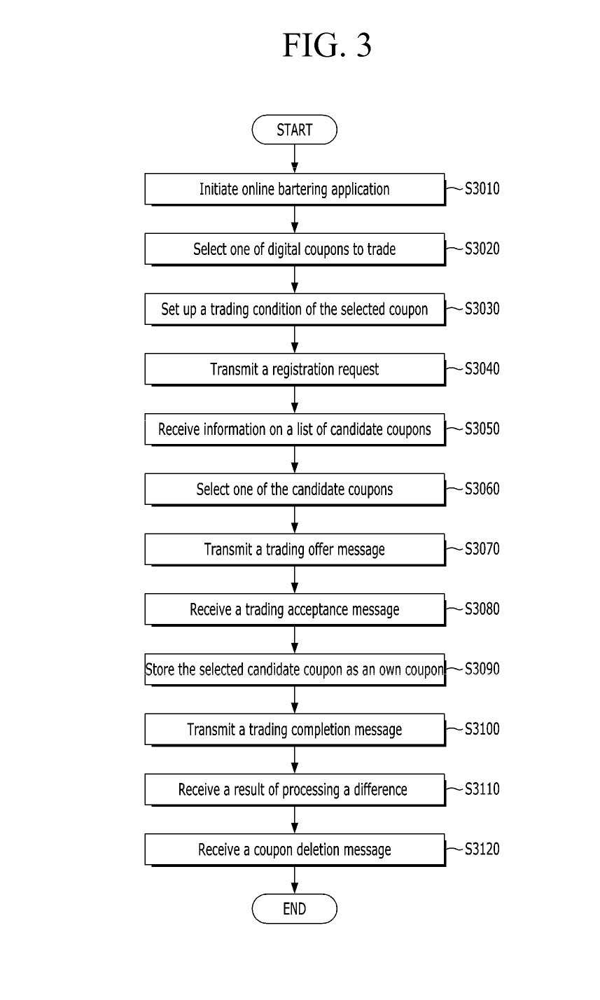

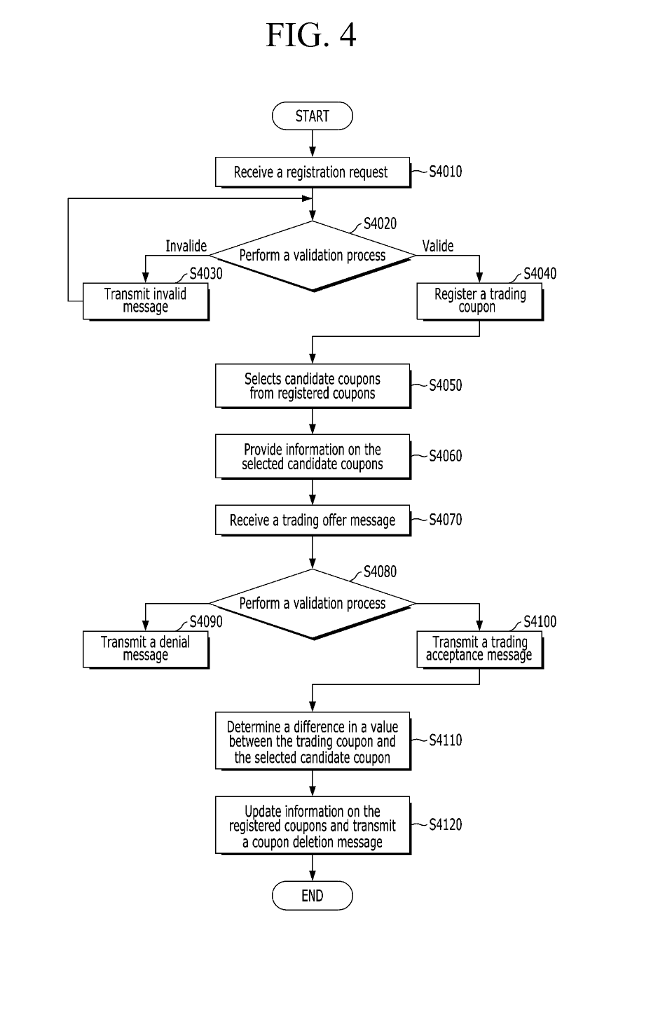

Search engine 220 searches goods having trading conditions matched with a trading condition of a trading good by scanning information on registered goods in DB 210 upon predetermined events. Search engine 220 provides a list of candidate goods as search results to respective user equipment. For example, search engine 220 finds registered goods each having a value greater or less than a value of a trading good, as much as a maximum allowed difference thereof. Search engine 220 provides a list of found goods as the search result to associated user equipment. Such searching operation will be described in more detail with reference to FIG. 3 and FIG. 4.

Processor 230 performs operations for providing an online bartering service. That is, processor 230 performs operations for bartering digital goods or services between two parties. For example, processor 230 performs a registration process in response to a registration request from user equipment. Particularly, processor 230 extracts information on a trading good from a registration request from user equipment and stores such extracted information in DB 210. Processor 230 performs a searching process and provides the searching result to respective user equipment. That is, processor 230 may control search engine 220 to search candidate goods and provide a list of candidate goods to respective user equipment.

Processor 230 also performs a bartering process for bartering goods between two user equipment. For example, i) first user equipment 110 receives information on a list of candidate goods, selects one of the candidate goods in response to a user input, and transmits such a selection signal to service server 200 with information on the selected candidate good. ii) Processor 230 receives the selection signal from first user equipment 110, searches for user equipment (e.g., second user equipment 120) associated with the selected candidate good, and transmits a trade offer message to second user equipment 120. iii) Processor 230 transmits one of a trade offer acceptance message or a trade offer denial message to first and second user equipment 110 and 120 in response to whether second user equipment 120 accepts the trade offer. When second user equipment 120 accepts the trade offer from first user equipment 110, second user equipment 120 transmits a trade offer acceptance message to service server 200. In this case, processor 230 might transmit a trade offer acceptance acknowledge message to second user equipment 120 and first user equipment 110.

Processor 230 performs a difference compensation process for processing a difference between two goods in association with associated virtual accounts. Particularly, processor 230 calculates a difference between two goods in a value. Processor 230 adds the calculated difference to or withdraws the calculated difference from associated virtual accounts. For example, when first user equipment 110 registers a first good and requests trading the first good with a second good of second user equipment 120, processor 230 calculates a difference in a value between the first good and the second good. When the first good is lower than the second good in a value, processor 230 deducts the difference from the remaining in a virtual account associated with first user equipment 110 and adds the difference to the remaining of a virtual account associated with second user equipment 120. When the first good is higher than the second good in a value, processor 230 adds such a difference to the remaining of a virtual account associated with first user equipment 110 and deducts the difference from the remaining of a virtual account associated with second user equipment 120.

Processor 230 performs operations for informing the remaining of the virtual account to associated user equipment after the difference compensation process. Furthermore, processor 230 performs operation for providing detailed information on traded goods to first and second user equipment 110 and 120 respectively after first user equipment 110 and second user equipment 120 trade goods to each other. As described, processor 230 of service server 200 performs operations for providing an online bartering service. Such operations will be described in more detail with reference to FIG. 4.

Before describing the detailed operation of service server 200, an online bartering operation performed in user equipment will be described with reference to FIG. 3. For convenience and ease of understanding, the online bartering operation will be described as bartering one of digital coupons stored in first user equipment 110 with another stored in second user equipment 120, but the present invention is not limited thereto. Any digital goods or services may be bartered through the online bartering operation in accordance with at least one embodiment. Furthermore, the online bartering operation will be described as using an online bartering application downloaded from service server 200 and installed in first user equipment 110, but the present invention is not limited thereto. The online bartering operation may be performed through a web-browser instead of executing an application installed in user equipment.

FIG. 3 illustrates an online bartering operation performed in user equipment in accordance with at least one embodiment. Referring to FIG. 3, an online bartering application installed in first user equipment 110 is initiated at step S3010. For example, when a user wants to barter one of digital coupons stored in first user equipment 110 with another belonging to others, the user initiates an associated online bartering application installed in first user equipment 110. That is, the user might activate an icon of the online bartering application displayed within a home screen of first user equipment 110.

At step S3020, one of digital coupons stored in first user equipment 110 is selected for trading. For example, as a result of the initiation of the online bartering application, a graphic user interface may be displayed on first user equipment 110. Through such a graphic user interface of the initiated application, the user is enabled to select one of digital coupons stored in first user equipment 110 for trading. Such a selected coupon for trading is referred to as a trading coupon, hereinafter.

At step S3030, a trading condition of the selected digital coupon is set up. For example, a trading condition denotes conditions for trading the selected digital coupon. That is, the trading condition may be preferences of coupons that the user wants to have. The trading condition includes a maximum allowed difference, a preferred coupon type, a preferred applicable merchant, a preferred valid period, and so forth. The maximum allowed difference is a maximum difference that a user allows service server 200 to barter a trading coupon with other coupons. That is, there may be a difference between two coupons in a value. Service server 200 might determine a coupon as a candidate coupon of a trading coupon if a difference between the coupon and the trading coupon is smaller than or equal to the maximum allowed difference. Accordingly, service server 200 selects coupons from registered coupons in DB 210 as candidate coupons in consideration of the maximum allowed difference and automatically process a difference between the trading coupon and the candidate coupon within the maximum allowed difference in connection with associated virtual account after the trading coupon is traded with one of the candidate coupons. The user may set up such a trading condition of the selected digital coupon through the graphic user interface of the online bartering application.

At step S3040, a registration request is transmitted to service server 200. For example, first user equipment 110 generates a registration request to include information on the trading coupon and information on the trading condition thereof and transmits the generated registration request to service server 200. In response to the registration request, service server 200 performs a registration process of the trading coupon of first user equipment 120.

At step S3050, information on a list of candidate coupons is received from service server 200. For example, first user equipment 120 receives information on a list of candidate coupons from service server 200 automatically in response to the registration request or upon a predetermined event. Such a predetermined event may be the transmission of a trading request. Such trading request may be invoked by receiving a user input for initiating trading one of digital coupons after the registration. The candidate coupons are coupons registered at service server 200 and having a trading condition that might be matched with a trading condition of the trading coupon. After receiving the registration request, service server 200 searches the candidate coupons based on the trading condition of the trading coupon. Such searching operation of service server 200 will be described in detail with reference to FIG. 4.

At step S3060, one of candidate coupons is selected based on a user selection input. For example, first user equipment 110 displays the received list of candidate coupons to the user and receives a selection input for selecting one of the candidate coupons from an associated user.

At step S3070, a trading offer message is transmitted to service server 200. For example, first user equipment 110 generates a trading offer message to include information on the selected candidate coupon and transmits the trading offer message to service server 200. Service server 200 may deliver the trading offer message to user equipment (e.g., second user equipment 120) associated with the selected candidate coupon. As a result of the trading offer message, service server 200 may receive one of a trading denial message and a trading acceptance message from second user equipment 120.

At step S3080, a trading acceptance message is received with detailed information on the selected candidate coupon. For example, when second user equipment 120 accepts the trading offer message of first user equipment 110, first user equipment 110 receives the trading acceptance message from second user equipment 120 through service server 200.

At step S3090, the selected candidate coupon is stored as an own coupon based on the received detailed information on the selected candidate coupon. For example, first user equipment 110 extracts the detailed information on the selected candidate coupon from the trading acceptance message and stores the extracted information on the selected candidate coupon as the own coupon.

At step S3100, a trading completion message is transmitted to service server 200. For example, after storing the information on the selected candidate coupon, first user equipment 110 generates and transmits the trading completion message to service server 200.

At step S3110, a result of processing a difference in a virtual account is received. For example, first user equipment 110 receives information on processing of a difference between the trading coupon and the selected candidate coupon. That is, service server 200 calculates the difference between the trading coupon and the selected candidate coupon and adds the calculated difference to or deducts the calculated difference from associated virtual account.

At step S3120, a coupon deletion message is received and information on the trading coupon is deleted. For example, first user equipment 110 may receive a coupon deletion message from service server 200 after service server 200 updates information on the registered coupons. Upon the receipt of the coupon deletion message, first user equipment 110 may delete information on the trading coupon or mark the trading coupon as expired or traded.

As described, user equipment barters own coupons with others through service server 200. Hereinafter, an online bartering operation performed in service server 200 will be described with reference to FIG. 4.

FIG. 4 illustrates an online bartering operation performed in a service server in accordance with at least one embodiment. Referring to FIG. 4, service server 200 receives a registration request from user equipment 110 for registering coupons (referred to as trading coupons) to trade at step S4010. For example, such registration request may be generated through an associated application installed and executed in user equipment 110. A user of first user equipment 110 activates such application and a graphic user interface of the activated application enables a user to register at least one of digital coupons stored therein at service server 200 for bartering or trading and to request service server 200 to find candidate coupons to be traded. In response to such activation of the application and selection of one of the digital coupons as a trading coupon, first user equipment 110 transmits a registration request to service server 200. First user equipment 110 generates the registration request to include information on the trading coupon with a trading condition. Particularly, the information on the trading coupon may include information on a coupon image, a coupon identifier (ID), a coupon issuance company (e.g., an Internet address of an issuance server), a value, a coupon type, a valid period, an applicable merchant, and so forth, but the present invention is not limited thereto. The trading condition may include information on a maximum allowed difference, a preferred coupon type, a preferred applicable merchant, and so forth, but the present invention is not limited thereto.

At step S4020, service server 200 performs a validation process upon the receipt of the registration request. For example, service server 200 may extract information necessary for the validation process from the registration request. Particularly, information on a coupon identifier, an Internet address of an issuance server, and a valid period may be extracted from the registration request, but the present invention is not limited thereto. Based on such extracted information, service sever 200 accesses the issuance server and requests validation of the trading coupon by transmitting the extracted information such as the coupon identifier and the valid period associated with the trading coupon.

In response to such request, service server 200 may receive one of an invalid message and a valid message from the issuance server. For example, the issuance server may determine whether a valid period of a trading coupon is expired or determine whether the trading coupon is illegally created or forged based on the received information such as a coupon identifier. When the valid period of the trading coupon is expired or when the coupon identifier is determined as forged, the issuance server transmits an invalid message to service server 200. Otherwise, the issuance server transmits a valid message to service server 200.

Such validation process may be realized in various methods. Accordingly, the present invention is not limited to one specific method. Furthermore, the online bartering operation of service server 200 was described as performing the validation process S4020 upon the receipt of the registration request, but the present invention is not limited thereto. Such validation process S4020 may be omitted in another embodiment. For example, service server 200 may perform the following registration process without validating the trading coupon in connection with the issuance server.

Upon the receipt of the invalid message (Invalid-S4020), service server 200 transmits an invalidation message to first user equipment 110 at step S4030. Such an invalidation message may include information on a reason of invalidation. Upon the receipt of the invalidation message, first user equipment 110 may display such information of the invalidation message through an associated display thereof.

Upon the receipt of the valid message, service server 200 registers the trading coupon in association with information on first user equipment 110 in response to the registration request at step S4040. For example, upon the receipt of the registration request from first user equipment 110, service server 200 extracts information on the trading coupon and the associated trading condition from the registration request and stores the extracted information in DB 210 of service server 200 in association with information of first user equipment 110. Such extracted information may be stored in a form of a mapping table in DB 210, but the present invention is not limited thereto.

Service server 200 may extract the coupon information and the trading condition information from the registration request. The coupon information may include information on a coupon image, a code pattern image thereof, a coupon identifier (ID), a coupon issuance company (e.g., an Internet address of an issuance server), a value, a coupon type, a valid period, an applicable merchant, and so forth. The trading condition information may include information on a maximum allowed difference, a preferred coupon type, a preferred applicable merchant, and so forth,

At step S4050, service server 200 selects candidate coupons having trading conditions matched with the trading condition of the trading coupon through scanning information stored in DB 210 of service server 200. For example, service server 200 compares the trading condition of the trading coupon with trading conditions of coupons registered at service server 200 by the others. If predetermined properties of the trading conditions are matched with each other, service server 200 selects such coupons as candidate coupons for trading. The preferred properties may be at least one of a value, a preferred coupon type, and a preferred applicable merchant, but the present invention is not limited thereto. Such a method for selecting candidate coupons may be modified in various ways.

In one embodiment, service server 200 searches for coupons each having a value greater or less than that of the trading coupon as much as the maximum allowed difference and selects the searched coupons as the candidate coupons. That is, service server 200 selects coupons having a value within a candidate value range (maximum allowed difference+the value of the trading coupon) and (the value of the trading coupon−maximum allowed difference).

In some embodiments, service server 200 may consider other properties as well as the value. For example, after finding registered coupons having values in the candidate value range, service server 200 may select, from the found coupons, coupons having a preferred applicable merchant matched with that in the trading condition of the trading coupon as candidate coupons. As described, such selection method may be realized in various ways.

At step S4060, service server 200 provides information on candidate coupons to first user equipment 110. For example, the information on candidate coupons may be a list of candidate coupons. Service server 200 may provide such candidate coupon list information automatically after receiving the registration request from first user equipment 110 or upon a predetermined event. The predetermined event may be the receipt of a trading request from first user equipment 110. Until such event, service server 200 may store information on the candidate coupon list in DB 210.

First user equipment 110 receives such information on candidate coupon list and displays the candidate coupon list within an associated graphic user interface in order to enable a user to select at least one of the candidate coupons. A user of first user equipment 110 may select one of candidate coupons and request bartering the trading coupon with the selected candidate coupon to service server 200. That is, upon the selection input and the requesting input, first user equipment 110 may transmit a trading offer message. Such a trading offer message includes information on the selected candidate coupon and information on the trading coupon that first user equipment 110 wants to trade.

At step S4070, service server 200 receives a trading offer message from first user equipment 110. For example, service server 200 receives the trading request including information on the selected candidate coupon as a result of providing the information on the candidate coupon list.

At step S4080, service server 200 determines user equipment (e.g., second user equipment 120) associated with the selected candidate coupon and delivers the received trading offer message to second user equipment 120. For example, service server 200 may extract information on the user equipment (e.g., second user equipment 120) associated with the selected candidate coupon from the trading request from first user equipment 110. Based on such information, service server 200 transmits the trading request to second user equipment 120. Furthermore, service server 200 also calculates a difference in value between the trading coupon and the selected candidate coupon and transmits information on the calculated difference to second user equipment 120. Second user equipment 120 displays such information on the calculated difference to the associated user through an associated graphic user interface.

Upon the receipt of the trading offer message from service server 200, second user equipment 120 displays information on the trading coupon of first user equipment 110 and information on the selected candidate coupon that is one of coupons of second user equipment 120 within an associated graphic user interface. Based on such information, a user associated with second user equipment 120 is enabled to determine whether to accept such trading offer from first user equipment 110. When the trading offer is accepted, second user equipment 120 transmits a trading acceptance message to service server 200. Otherwise, second user equipment 120 transmits a trading denial message to service server 200.

Upon the receipt of the trading denial message from second user equipment 120, service server 200 transmits a denial message to first user equipment 110 at step S4090. In this case, first user equipment 110 may display such a denial message and inquire the associated user to select another from the candidate coupons.

Upon the receipt of the trading acceptance message from second user equipment 120, service server 200 transmits the trading acceptance message with detail information on the selected candidate coupon to first user equipment 110 and transmits detail information on the trading coupon to second user equipment 120 at step S4100. Upon the receipt of the trading acceptance message with the detail information on the selected candidate coupon, first user equipment 110 may display the trading acceptance message and store the detailed information on the selected candidate coupon therein as an own applicable coupon. The detailed information may include a coupon image, a code pattern image thereof, a coupon identifier (ID), a coupon issuance company (e.g., an Internet address of an issuance server), a value, a coupon type, a valid period, an applicable merchant, and so forth. After storing the detailed information of the selected candidate coupon as the own applicable coupon, first user equipment 110 may transmit a trading completion message to service server 200.

Upon the receipt of the detail information on the trading coupon, second user equipment 110 also display the detailed information on the trading coupon and store the detailed information as an own applicable coupon. As described, the detailed information may include a coupon image, a code pattern image thereof, a coupon identifier (ID), a coupon issuance company (e.g., an Internet address of an issuance server), a value, a coupon type, a valid period, an applicable merchant, and so forth. After storing the detailed information of the trading coupon of first user equipment 110 as the own applicable coupon, second user equipment 120 may transmit a trading completion message to service server 200.

At step S4110, service server 200 determines a difference in a value between the trading coupon and the selected candidate coupon and compensates the determined difference to virtual accounts associated with first and second user equipment 110 and 120. Such determination may be performed upon the receipt of the trading completion message from first and second user equipment 110 and 120. For example, when the value of the trading coupon is $5.00 and the value of the selected candidate coupon is $3.00, service server 200 adds $2.00 to a virtual account associated with first user equipment 110 and deducts $2.00 from a virtual account associated with second user equipment 120.

At step S4120, service server 200 updates information on the registered coupons stored in DB 210 and transmits a coupon deletion message to first and second user equipment 110 and 120. In response to the coupon deletion message, first user equipment 110 may delete information on the trading coupon and second user equipment 120 may delete information on the selected candidate coupon. Alternatively, in response to the coupon deletion message, first user equipment 110 may mark the trading coupon as traded or expired and second user equipment 120 may mark the selected candidate coupon as traded or expired.

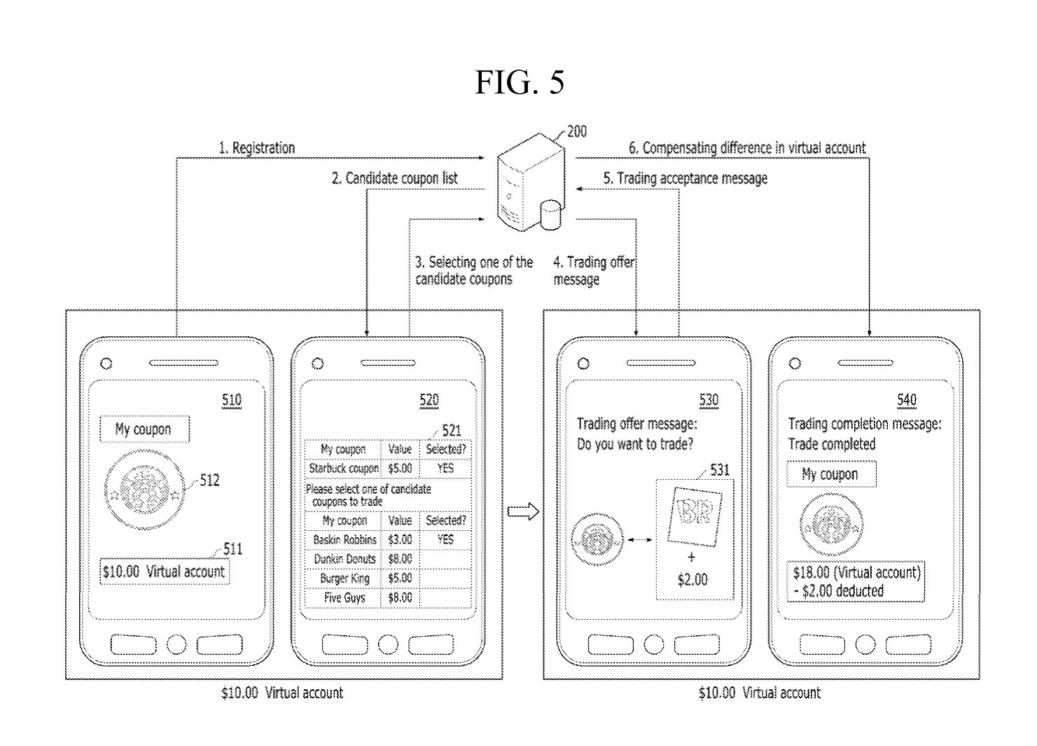

FIG. 5 illustrates an online bartering operation for bartering a coffee shop coupon with an ice cream shop coupon in accordance with at least one embodiment. With reference to FIG. 5, an online bartering operation will be described as bartering $5.00 Starbucks coupon stored in first user equipment 110 with $3.00 Baskin Robbins coupon stored in second user equipment 120.

1. Registration

As shown in graphic user interface 510 of first user equipment 110, a first user of first user equipment 110 has a virtual account with $10.00 remaining 511. The first user registers Starbucks coupon 512 having a value of $5.00 with a trading condition including a maximum allowed difference of $2.00 at service server 200 through first user equipment 110.

Although it is not shown, a second user of second user equipment 120 has a virtual account with $20.00 remaining The second user registers a Baskin Robbins coupon having a value of $3.00 with a maximum allowed difference of $2.00 at service server 200 through second user equipment 120.

Upon the registration request from first user equipment 110 and second user equipment 120, service server 200 performs a validation process of the Starbucks coupon and the Baskin Robbins coupon in connection with related issuance servers of the Starbucks coupon and the Baskin Robbins coupon. After the validation process, service server 200 stores detailed information on the Starbucks coupon and the Baskin Robbins coupon in association with first user equipment 110 and second user equipment 120 as a result of registration.

2. Candidate Coupon List

When the first user wants to trade the Starbucks coupon, the first user may control first user equipment 110 to transmit a trading request to service server 200. In response to the trading request, service server 200 provides first user equipment 110 with a list of candidate coupons having a trading condition matched with that of the Starbucks coupon. As shown in graphic user interface 520 of first user equipment 110, first user equipment 110 displays candidate coupon list 521 based on the received information.

3. Selecting One of the Candidate Coupons

The first user selects one of candidate coupons 521. Then, first user equipment 110 generates a trading offer message to include information on a selected candidate coupon (e.g., Baskin Robbins coupon) to service server 200.

4. Trading Offer Message

Service server 200 transmits the trade offering message with the selected candidate coupon (e.g., Baskin Robbins coupon) to second user equipment 120. As shown in graphic user interface 530 of second user equipment 120, second user equipment 120 may display the received trade offering message thereon. Since there is $2.00 difference between the Starbucks coupon and the Baskin Robbins coupon, service server 200 informs second user equipment 120 that the second user needs to pay $2.00 additionally to first user equipment 110 as shown in message 531 of graphic user interface 530.

5. Trading Acceptance Message

When the second user accepts the trading offer from the first user, second user equipment 120 transmits the trading acceptance message to service server 200. Service server 200 provide detailed information on the Starbuck coupon to second user equipment 120 and detailed information on the Baskin Robbins coupon to first user equipment 110.

6. Compensating Difference in Virtual Account

Service server 200 calculates $2.00 as a difference between the Starbucks coupon and the Baskin Robbins coupon. Then, service server 200 adds $2.00 to a virtual account associated with first user equipment 110 and deducts $2.00 from a virtual account associated with second user equipment 120. After processing the difference, service server 200 informs first and second user equipments 110 and 120 with the processing result. For example, graphic user interface 540 of second user equipment 120 shows that the Starbucks coupon is stored in second user equipment 120 and $18.00 is remained in the virtual account associated with second user equipment 120 after the difference is deducted therefrom.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing an online bartering service by a service server, the method comprising:
registering a trading coupon of first user equipment in response to a registration request from the first user equipment;
providing information on a list of candidate coupons to the first user equipment based on information on the trading coupon of the first user equipment;
receiving a trading offer message with information on a selected candidate coupon from the first user equipment and transmitting the trading offer message to second user equipment having the selected candidate coupon; and
automatically processing a difference between the trading coupon and the selected candidate coupon in connection with associated virtual accounts upon receiving a trading acceptance message from the second user equipment.

2. The method of claim 1, wherein the registering a trading coupon of first user equipment comprises:
receiving the registration request from the first user equipment with information on the trading coupon and a trading condition;
extracting the information on the trading coupon and the trading conditions from the received registration request;
storing the extracted information on the trading coupon and the trading condition in association with information on the first user equipment in a database of the service server.

3. The method of claim 2, wherein:
the information on the trading coupon includes at least one of a name, a coupon type, a coupon image, a coupon identifier, a code pattern image, an applicable merchant, a valid period, a value, an Internet address of an issuance server, and an associated virtual account; and
the information on the trading condition of the trading good includes at least one of a maximum allowed difference, a preferred coupon type, a preferred applicable merchant, and a preferred valid period.

4. The method of claim 1, wherein the providing a list of candidate coupons comprises:
obtaining information on the trading coupon of the first user equipment and an associated trading condition;
searching registered coupons each having a trading condition matched with the obtained trading condition of the trading coupon;
generating a list of candidate coupons based on the searching result; and
providing the generated list of the candidate coupons to the first user equipment.

5. The method of claim 4, wherein the trading condition includes at least one of a maximum allowed difference, a preferred coupon type, a preferred applicable merchant, and a preferred valid period.

6. The method of claim 4, wherein the searching registered coupons comprises:
determining a registered coupon of another as a candidate coupon when a difference in value between the registered coupon and the trading coupon is equal to or smaller than a maximum allowed difference set as the trading condition of the trading coupon of the first user equipment.

7. The method of claim 1, wherein the providing a list of candidate coupons comprises:
of coupons previously registered at the service server, selecting coupons each having a value equal to a value of the trading coupon as the candidate coupons;
of the coupons previously registered at the service server, selecting coupons each having a value less than a value of the trading coupon as much as a maximum allowed difference set as the trading condition of the trading coupon as the candidate coupons; and
of the coupons previously registered at the service server, selecting coupons each having a value greater than a value of the trading coupons as much as the maximum allowed difference of the trading coupon.

8. The method of claim 1, wherein the receiving a trading offer message comprises:
obtaining information on the selected candidate coupon from the received trading offer message;
determining user equipment having the selected candidate coupon, as the second user equipment, based on information on the selected candidate coupon stored in a database when the selected candidate coupon is registered in response to a registration request from the second user equipment; and
transmitting the received trading offer message to the determined user equipment with information on the trading coupon.

9. The method of claim 1, comprising:
receiving the trading acceptance message from the second user equipment in response to the trading offer message; and
providing detailed information on the trading coupon of the first user equipment to the second user equipment and providing detailed information on the selected candidate coupon of the second user equipment to the first user equipment.

10. The method of claim 1, wherein if the difference is equal to or smaller than a maximum allowed difference of the trading good, the automatically processing a difference comprises:
calculating a difference in a value between the trading good and the selected candidate good; and
compensating the first and second user equipment based on the calculated difference in connection with virtual accounts associated with the first and second user equipment.

11. The method of claim 10, wherein the compensating the first and second user equipment comprises:
when a value of the trading coupon is greater than a value of the selected candidate coupon, automatically adding the calculated difference to a virtual account associated with the first user equipment and automatically deducting the calculated difference from a virtual account associated with the second user equipment; and
when a value of the trading coupon is less than a value of the selected candidate coupon, automatically adding the calculated difference to a virtual account associated with the second user equipment and automatically deducting the calculated difference from a virtual account associated with the first user equipment.

12. The method of claim 1, after the automatically processing, comprising:
receiving a trading completion message from the first and second user equipment; and
providing information on a result of the processing the difference to the first and second user equipment.

13. The method of claim 1, after the automatically processing, comprising:
changing information on the trading coupon as belonging to the second user equipment and information on the selected candidate coupon as belonging to the first user equipment; and
transmitting a coupon deletion message to the first and second user equipment,
wherein the first user equipment deletes information on the trading coupon and marks the trading coupon as traded in response to the coupon deletion message and the second user equipment deletes information on the selected candidate coupon and marks the selected candidate coupon as traded in response to the coupon deletion message.

14. A method of receiving an online bartering service at first user equipment, the method comprising:
transmitting a request including information on a trading coupon and a trading condition thereof to a service server;
receiving from the service server information on a list of candidate coupons each having a trading condition matched with the trading condition of the trading coupon; and
transmitting a trading offer message including information on a selected candidate coupon to the service server.

15. The method of claim 14, wherein the transmitting a request comprises:
displaying a list of coupons stored in the first user equipment;
receiving a selection input from an associated user for selecting one of the stored coupons;
setting a trading condition of the selected coupon based on user input; and
generating the request to include information on the selected coupon as the trading coupon and information on the trading condition thereof.

16. The method of claim 15, wherein:
the information on the trading coupon includes at least one of a name, a coupon type, a coupon image, a coupon identifier, a code pattern image, an applicable merchant, a valid period, a value, an Internet address of an issuance server, and an associated virtual account; and
the information on the trading condition of the trading good includes at least one of a maximum allowed difference, a preferred coupon type, a preferred applicable merchant, and a preferred valid period.

17. The method of claim 15, wherein the setting a trading condition comprises:
setting a maximum allowed difference for enabling the service server to select candidate coupons and to automatically process a difference between the trading coupon and a selected candidate coupon in connection with associated virtual accounts if a difference between the trading coupon and the selected candidate coupon is equal to or smaller than the maximum allowed difference.

18. The method of claim 13, comprising:
receiving from the service server at least one of a trading acceptance message and a trading denial message in response to the trading offer message;
upon the receipt of the trading acceptance message, extracting detailed information on the selected candidate coupon from the trading acceptance message, storing the extracted information and marking the selected candidate coupon as an own coupon, and transmitting a trading completion message to the service server.

19. The method of claim 13, comprising:
receiving from the service server information on a result of automatically processing a difference between the trading coupon and the selected candidate coupon in connection with a virtual account associated with the first user equipment; and
deleting the information on the trading coupon and marking the trading coupon as traded upon the receipt of a coupon deletion message from the service server.

20. A service server of an online bartering service, the service server configured to:
register a trading coupon of first user equipment in response to a registration request from the first user equipment;
provide information on a list of candidate coupons to the first user equipment based on information on the trading coupon of the first user equipment;
receive a trading offer message with information on a selected candidate coupon from the first user equipment and transmit the trading offer message to second user equipment having the selected candidate coupon; and
automatically process a difference between the trading coupon and the selected candidate coupon in connection with associated virtual accounts upon receiving a trading acceptance message from the second user equipment.
